(19) United States
(12) Patent Application Publication
(10) Pub. No.: US 2021/0178205 A1
(43) Pub. Date: Jun. 17, 2021

(54) COMPACT RESCUE APPARATUS AND METHOD

(71) Applicant: RKO Enterprises, Madison, IN (US)

(72) Inventor: Kieth Olson, Madison, IN (US)

(21) Appl. No.: 17/123,986

(22) Filed: Dec. 16, 2020

Related U.S. Application Data
(63) Continuation-in-part of application No. 29/717,379, filed on Dec. 17, 2019.
(60) Provisional application No. 62/949,071, filed on Dec. 17, 2019.

(51) Int. Cl. A62B 99/00; B60P 3/42; B60R 11/00; B62D 39/00

(52) U.S. Cl. CPC A62B 99/00; B60P 3/423; B60R 2011/0084; B62D 39/00; B60R 2011/0036; B60R 11/00

(57) ABSTRACT

A compact rescue kit that has a base section, a caregiver seat assembly coupled to the base section, a basket section configured to receive and secure a patient basket, and a cylinder support configured to carry a compressed gas. The base section is configured to be secured to a compact off-road vehicle.

### CROSS-REFERENCE TO RELATED APPLICATION

The present disclosure claims the benefit of U.S. Provisional Application No. 62/949,071 filed Dec. 17, 2019, the contents of which are hereby incorporated herein in entirety.

### FIELD OF THE DISCLOSURE

The present disclosure relates to an apparatus to assist with search and rescue and more specifically with an apparatus that can be implemented on a compact off-road vehicle.

### BACKGROUND OF THE DISCLOSURE

Search and rescue teams are often called to remote areas that are very difficult to access. Often, a team of search and rescue personnel must hike or otherwise travel over difficult terrain. Once the team reaches the person in need they must either carry the person out or wait for an air-lift to remove the person in need. This can be very time consuming and difficult when an air-lift is not available.

### SUMMARY

One embodiment is a compact rescue kit. The kit includes a base section, a caregiver seat assembly coupled to the base section, a basket section configured to receive and secure a patient basket, and a cylinder support configured to carry a compressed gas. Further, the base section is configured to be secured to a compact off-road vehicle.

In one example of this embodiment, the caregiver seat assembly includes a support section and a seat section. In one aspect of this example, the cylinder support is coupled to the support section.

Another example of this embodiment includes a bag support extension coupled to the base section. Yet another example includes an anchoring assembly on the base section, wherein the anchoring assembly is configured to secure the base section to the compact off-road vehicle.

In yet another embodiment, the basket section has a first wall and a second wall spaced from one another to partially receive a basket assembly therebetween. In one aspect of this example the first wall and the second wall have a couplers thereon configured to selectively couple the basket assembly to the base section. In yet another aspect of the seat section example the seat section has a seatbelt to selectively secure the caregiver to the seat section.

In another example of this embodiment, the cylinder support has at least one cylinder strap coupled thereto to selectively secure a cylinder to the cylinder support. In yet another example, the cylinder support has an upturned edge configured to partially cradle a cylinder between the upturned edge and the caregiver seat assembly. In another aspect of the bag support extension example, the bag support extension is reconfigurable between a full length configuration and a reduced configuration.

In one example of this embodiment, the basket section is sized so a fully assembled basket will extend off of the base section. In one aspect of this example, the basket section has support straps to secure the fully assembled basket thereto wherein the basket is sufficiently secured to the base section when the basket is in the fully assembled configuration and a person is positioned therein.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIGS. 1-7 illustrate various views of a compact rescue kit either coupled to a compact off-road vehicle or isolated therefrom.

Corresponding reference numerals are used to indicate corresponding parts throughout view.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

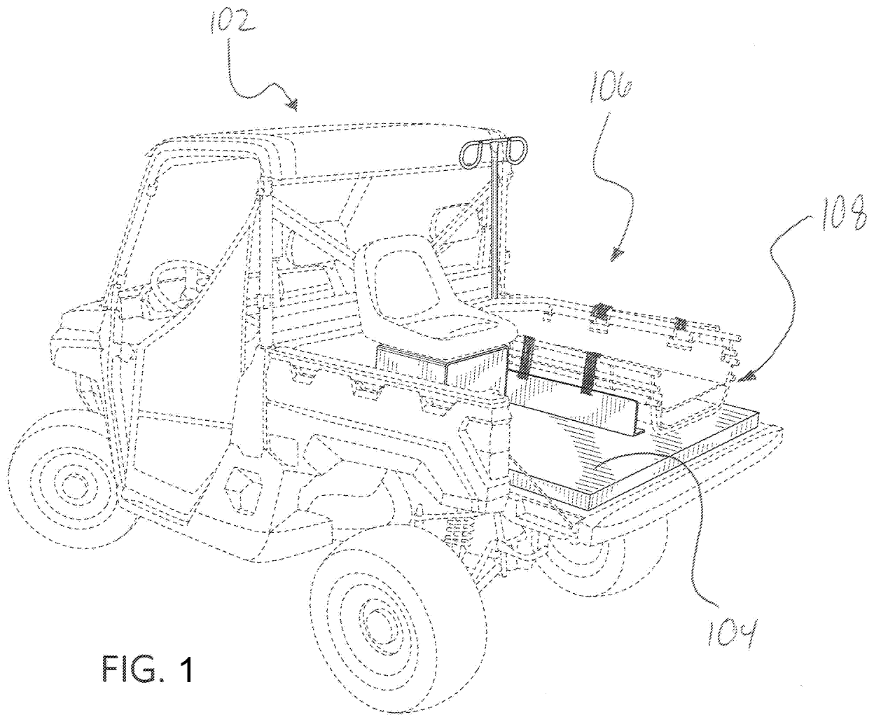

Referring to FIG. 1, a compact rescue kit 100 is illustrated coupled to a compact off-road vehicle 102. The vehicle 102 may be any all-terrain vehicle configured for off-road use. In one non-exclusive example, the vehicle 102 may be a “side-by-side” type vehicle such as the one described in U.S. Pat. No. 9,434,244, the contents of which are hereby incorporated herein by reference. However, any vehicle with a cargo bed is considered herein. Accordingly, trucks, ATVs, tractors, and any other vehicle that may have a cargo bed to receive the compact rescue kit 100 are considered herein.

The compact rescue kit 100 may have a base section 104 that is sized to at least partially fit in a cargo bed 106 of the compact off-road vehicle 102. The base section may be formed of metal, plastic, or any other type of material that is sufficiently strong to provide a support for the components of the compact rescue kit 100. In one aspect of this example, the compact rescue kit 100 is secured to the compact off-road vehicle 102 via one or more anchoring assembly 202 of the base section 104. The anchoring assembly may provide a location to selectively mechanically couple the base section 104 to the compact off-road vehicle 102. In one aspect of this disclosure, the anchoring assembly 202 may be fasteners or the like that secure the base section 104 to a structural portion of the compact off-road vehicle 102 such as the chassis. Regardless of the type or location of the anchoring assembly 202, the anchoring assembly 202 may selectively couple the base section 104 to the cargo bed 106 to ensure the compact rescue kit 100 remains securely therein during off-road travel.

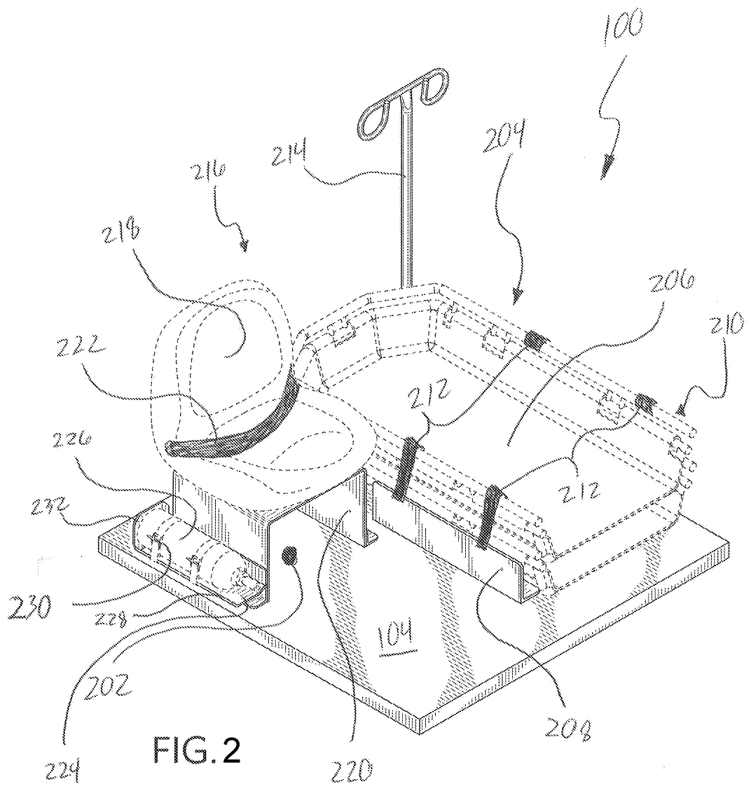

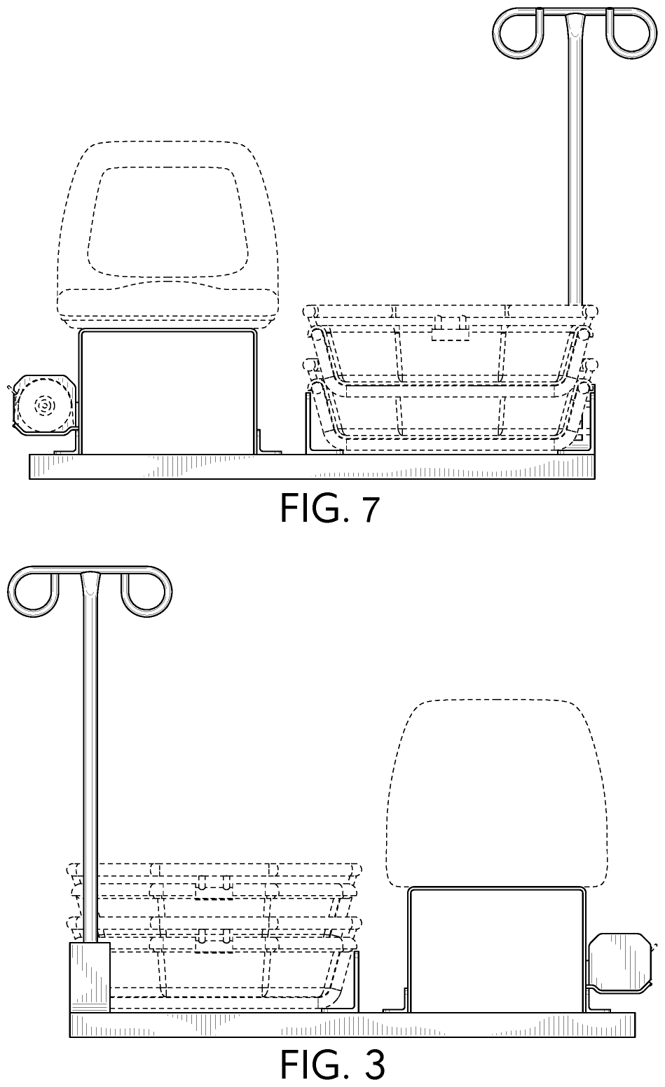

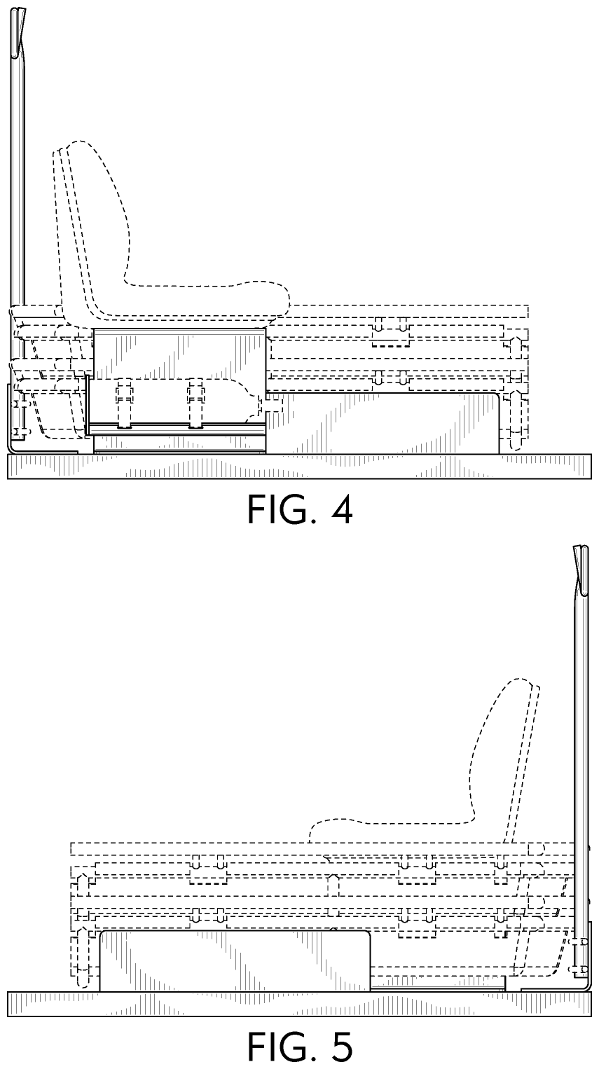

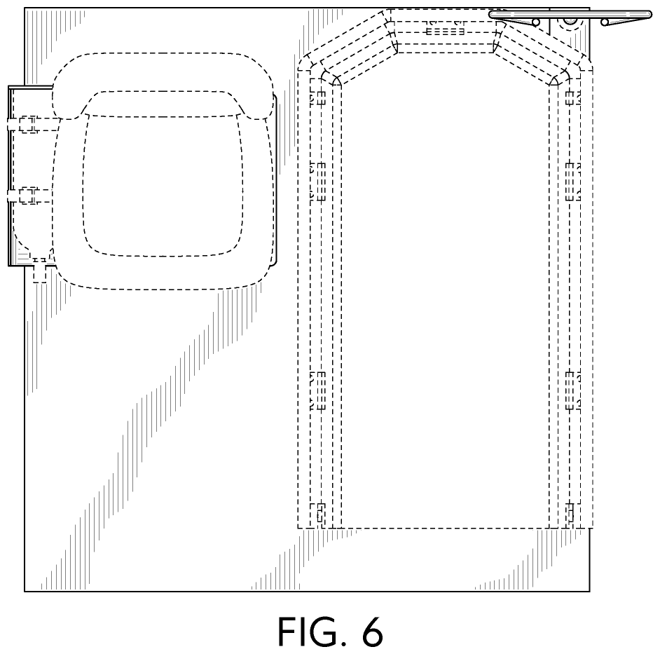

Referring now to FIG. 2, the compact rescue kit 100 is illustrated separated from the compact off-road vehicle 102. More specifically, a basket section 204 is illustrated coupled to the base section 104. The basket section 204 may be sized to receive and secure a basket assembly 206 to the base section 104. In one non-exclusive example, the basket section 204 may have a first wall 208 and a second wall 210 coupled to the base section 104. The first and second wall 208, 210 may be spaced from one another to allow the basket assembly 206 to fit at least partially there between. Further, the first and second walls 208, 210 may also have couplers 212 thereon to selectively couple the basket assembly 206 to the walls 208, 210 and in turn to the base section 104.

In one aspect of this disclosure the compact rescue kit 100 may receive a segmented basket assembly 206 therein. The segmented basket assembly 206 may have a reduced size and a use size. In one non-limiting example, the basket assembly 206 may be formed of two portions that can be selectively oriented in the use size or stacked on one another in the reduced size. When the compact rescue kit 100 is being deployed on a compact off-road vehicle 102 to a rescue site, the basket assembly 206 may be coupled to the base section 104 in the reduced size configuration to make the compact off-road vehicle 102 more compact as the vehicle 102 travels to the rescue site. In the reduced size configuration, the couplers 212 may hold the basket assembly 206 to the base section 104 in the basket section 204 in the reduced size.

Once the vehicle 102 reaches the rescue site, the coupler 212 may be removed and the basket assembly 206 converted to the use size to accommodate the injured party. The injured party may be positioned in the basket assembly 206 in the use size and the basket assembly 206 may be placed back in the basket section 204 of the compact rescue kit 100. Then, the couplers 212 may couple the basket assembly 206 to the base section 104 to ensure the basket section 204 and the injured party are securely coupled to the vehicle 102. In one embodiment of this disclosure, the basket assembly may extend past the base section 104 in the use size. In this configuration, the couplers 212 also sufficiently support the basket assembly 206 to ensure it does not fall off the base section 104 in spite of extending at least slightly past the base section 104.

The base section 104 may also have a bag support extension 214 coupled thereto. The bag support extension 214 may be configured to elevate a medical bag that contains a solution meant for intravenous therapy. The bag support extension 214 may hold the medical bag above the basket section 204 to allow medicine, nutrients, and the like to flow therefrom into the injured party. In one aspect of this disclosure, the bag support extension 214 may have a plurality of looped ends for coupling one or more medical bag thereto. Further still, in one aspect of this disclosure the bag support extension 214 may be reconfigurable between a raised position and a lowered position. In this example, the bag support extension 214 may be in the lowered position when the compact off-road vehicle 102 is travelling to the injured party to ensure the vehicle 102 remains as compact as possible while travelling through rough terrain. Once the vehicle 102 reaches the injured party, the bag support extension 214 may be reconfigured to the raised position and medical bags can be hung therefrom when the injured party is placed in the basket section 204 to dispense medicament thereto as the vehicle 102 transports the injured party to a more conventional treatment area.

In another aspect of this disclosure, a caregiver seat assembly 216 may be coupled to the base section 104 as well. The caregiver seat assembly 216 may have a seat section 218 coupled to a support section 220. Further, the support section 220 may be coupled to the base section 104 to ensure that the seat section 218 remains relatively fixed thereto. The seat section 218 may be configured to receive a caregiver therein. More specifically, the seat section 218 may have a back coupled to a bottom portion wherein the caregiver can sit and tend to an injured party in the basket section 204. Further, the seat section 218 may have a seatbelt or harness 222 that ensures the caregiver remains in the seat section 218 as the vehicle 102 traverses rugged terrain.

The support section 220 may elevated the seat section 218 from the base section 104 so the caregiver may sit therein with their knees at least partially bent. Further, the base section 104 may also provide a mounting location for a cylinder support 224. The cylinder support 224 may extend from a side of the support section 220 and provide a location to secure an oxygen bottle or the like 226 to the compact rescue kit 100. The cylinder support 224 may have an upturned edge 228 and one or more cylinder strap 230 thereon to secure the bottle 226 of compressed gas thereto. More specifically, the upturned edge 228 may be an outermost edge of the cylinder support 224 that runs longitudinally along the bottle 226. This configuration allows the upturned edges 228 to create a cavity within which the bottle 226 is at least partially cradled. To further ensure the bottle 226 remains in the cylinder support 224 the cylinder straps 230 may keep the bottle within the cavity created by the upturned edge 228 and the remaining portions of the cylinder support 224. Further, in one aspect of this disclosure the cylinder support 224 has a back end 232 that defines a backmost position for the bottle 226.

In use, the compact rescue kit 100 may easily be installed in a vehicle 102 simply by coupling the base section 104 to the vehicle 102 with the anchoring assembly 202. Further, once the base section 104 is coupled thereto the vehicle 102 may be used to travel to injured parties with a caregiver in the seat assembly 216 and the basket assembly 206 may be in the reduced size and coupled to the walls 208, 210 with the couplers 212. Once the vehicle 102 reaches the injured party, the couplers 212 may be released and the basket assembly 206 may be reoriented into the use size. The injured party may then be placed in the basket assembly 206 and the injured party and basket assembly 206 may be returned to the basket section 204. Once back in the basket section 204, the couplers 212 may couple the basket assembly 206 thereto to ensure the injured party remains safely positioned next to the caregiver in the seat assembly 216. The caregiver may utilize the bag support extension 214 in the raised position to flow fluid from a medical bag to the injured party. Further, the caregiver may access oxygen from the cylinder 226 in the cylinder support 224 to further provide the injured party with oxygenated air. Once the injured party is safely in the basket assembly 206 and secured to the base section 104, the vehicle 102 may transport the injured party through the rough terrain to a more suitable treatment area.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A compact rescue kit, comprising:
a base section;
a caregiver seat assembly coupled to the base section;
a basket section configured to receive and secure a patient basket; and
a cylinder support configured to carry a compressed gas;
wherein, the base section is configured to be secured to a compact off-road vehicle.

2. The kit of claim 1, further wherein the caregiver seat assembly comprises a support section and a seat section.

3. The kit of claim 2, further wherein the cylinder support is coupled to the support section.

4. The kit of claim 1, further comprising a bag support extension coupled to the base section.

5. The kit of claim 1, further comprising an anchoring assembly on the base section, wherein the anchoring assembly is configured to secure the base section to the compact off-road vehicle.

6. The kit of claim 1, further wherein the basket section has a first wall and a second wall spaced from one another to partially receive the patient basket therebetween.

7. The kit of claim 6, further wherein the first wall and the second wall have at least one coupler thereon configured to selectively couple the patient basket to the base section.

8. The kit of claim 2, further wherein the seat section has a seatbelt to selectively secure the caregiver to the seat section.

9. The kit of claim 1, further wherein the cylinder support has at least one cylinder strap coupled thereto to selectively secure a cylinder to the cylinder support.

10. The kit of claim 1, further wherein the cylinder support has an upturned edge configured to partially cradle a cylinder between the upturned edge and the caregiver seat assembly.

11. The kit of claim 4, further wherein the bag support extension is reconfigurable between a full length configuration and a reduced configuration.

12. The kit of claim 1, wherein the basket section is sized so a fully assembled patient basket will extend off of the base section.

13. The kit of claim 12, further wherein the basket section has support straps to secure the fully assembled patient basket thereto wherein the patient basket is sufficiently secured to the base section when the patient basket is in the fully assembled configuration and a person is positioned therein.

14. A method of modifying a compact off-road vehicle, comprising:
providing a compact rescue kit that has a base section, a caregiver seat assembly coupled to the base section, a basket section configured to receive and secure a patient basket, and a cylinder support configured to carry a compressed gas; and
coupling the base section to a compact off-road vehicle.

15. The method of claim 14, further comprising coupling a bag support extension to the base section.

16. The method of claim 14, further wherein the coupling the base section step comprises anchoring an anchoring assembly on the base section to the compact off-road vehicle to secure the base section to the compact off-road vehicle.

17. The method of claim 14, further comprising coupling the patient basket to the base section with at least one coupler.

18. The method of claim 14, further comprising positioning a cylinder at least partially in the cylinder support so an upturned edge of the cylinder support at least partially cradles the cylinder between the upturned edge and the caregiver seat assembly.

19. A compact rescue apparatus, comprising:
a base section;
a caregiver seat assembly coupled to the base section, the caregiver seat assembly having a support section and a seat section;
a basket section configured to receive and secure a patient basket, the basket section having at least one coupler thereon configured to selectively couple the patient basket to the basket section;
a cylinder support coupled to the support section and configured to carry a compressed gas;
a bag support extension configured to be coupled to the base section;
an anchoring assembly on the base section and configured to secure the base section to a compact off-road vehicle;
wherein, the base section is configured to be secured to a compact off-road vehicle.

20. The compact rescue apparatus of claim 19, wherein the basket section is sized so a fully assembled patient basket will extend off of the base section and the at least one coupler are configured to secure the fully assembled patient basket thereto wherein the patient basket is sufficiently secured to the base section when the basket is in the fully assembled configuration and a person is positioned therein.
